(19) United States
(12) Patent Application Publication
(10) Pub. No.: US 2026/0079737 A1
(43) Pub. Date: Mar. 19, 2026

(54) VIRTUAL ENVIRONMENT CACHING FOR SERVERLESS WORKLOADS

(71) Applicant: Databricks, Inc., San Francisco, CA (US)

(72) Inventors: Deka Auliya Akbar, San Francisco, CA (US); Mohammad Hossein Falaki, San Francisco, CA (US); Jaipreet Singh, Seattle, WA (US); Ran Wan, Seattle, WA (US); Jove Omega Yuan, San Francisco, CA (US)

(21) Appl. No.: 18/885,197

(22) Filed: Sep. 13, 2024

(51) Int. Cl. G06F 9/455; G06F 9/445

(52) U.S. Cl. CPC G06F 9/45558; G06F 9/44505; G06F 2009/45583

(57) ABSTRACT

A data processing service receives a request from a user to execute code in a notebook. The service initiates a first VM for execution of the code in the notebook based on the request. The first VM may be set up with a virtual environment with configurations for executing the code. The service automatically caches the virtual environment with the configurations in a data store and automatically caches metadata associated with the virtual environment in a metadata store. The metadata may include a location identifier for identifying a caching location of the virtual environment in the data store. The metadata may include an expiration condition. When the virtual environment meets the expiration condition, the virtual environment will be invalidated in the data store. The service executes the code in the notebook in the virtual environment.

### TECHNICAL FIELD

The disclosed configuration relates generally to databases, and more particularly to caching and synchronizing virtual environments in serverless computing systems.

### BACKGROUND

In serverless computing systems, a user typically submits their code or function requests, which are executed by managed services of a cloud provider. The managed services are operated through serverless systems, which are systems that manage and allocate compute resources without need for the user to manage those resources. That is, the serverless systems abstract away the underlying infrastructure, and the users do not maintain direct control over servers or virtual machines (VMs).

When cloud providers aggressively remove idle compute resources to save costs, there can be delays in provisioning new resources when new requests arrive. This results in noticeable lag as the system must once again initialize the necessary resources. For applications requiring real-time responsiveness or handling time-sensitive tasks the resulting delays significantly impact performance and user experience. The dynamic nature of resource allocation in serverless systems can lead to unpredictable performance. Users may experience varying execution times for their requests depending on the current load and how quickly resources are allocated. This inconsistency is problematic for applications requiring reliable and consistent performance.

Additionally, running a serverless notebook with logically and physically separated VMs and remote computing clusters introduces several issues. Maintaining consistency and synchronization between the local code executed in the VM and the pre-defined functions running on the remote clusters can be challenging. Ensuring that the VM and computing clusters are aligned in terms of data and code dependencies is essential for accurate and reliable performance. Different versions of libraries or software packages on the VM and computing clusters can lead to compatibility issues, causing errors or unexpected behavior in code execution. Managing dependencies and ensuring compatibility between the local VM environment and the remote computing clusters can be problematic.

### BRIEF DESCRIPTION OF THE DRAWINGS

The disclosed embodiments have other advantages and features which will be more readily apparent from the detailed description, the appended claims, and the accompanying figures (or drawings). A brief introduction of the figures is below.

FIG. 1 is a high-level block diagram of a system environment for a data processing service, in accordance with an embodiment.

FIG. 2 illustrates a block diagram of an architecture of a data storage system, in accordance with an embodiment.

FIG. 3 illustrates a block diagram of an architecture of a control layer, in accordance with an embodiment.

FIG. 4 is a block diagram of an architecture of the control layer and the data layer for performing serverless environment caching, in accordance with an embodiment.

FIG. 5 is a block diagram illustrating a process of synchronizing a virtual environment, in accordance with an embodiment.

FIG. 6 is a flowchart of a method for synchronizing a virtual environment, in accordance with an embodiment.

FIG. 7 is a flowchart of a method for caching a virtual environment, in accordance with an embodiment.

FIG. 8 is a block diagram illustrating an example machine to read and execute computer readable instructions, in accordance with an embodiment.

### DETAILED DESCRIPTION

The figures depict various embodiments of the present configuration for purposes of illustration only. One skilled in the art will readily recognize from the following discussion that alternative embodiments of the structures and methods illustrated herein may be employed without departing from the principles of the configuration described herein.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Overview

The disclosed configurations provide a system (and/or a computer-readable medium or method/process) for synchronizing a virtual environment. The configuration receives a request from a user to execute code (software or program code) in a notebook. The code includes pre-defined functions. The configuration initializes a virtual machine (VM) for executing the code in the notebook which is configured with a virtual environment. The configuration accesses a computing cluster for execution of the pre-defined functions. The computing cluster includes a driver node and one or more worker nodes. The configuration stores the virtual environment in a data store and provides metadata to the driver node. The metadata specifies a storage location of the virtual environment in the data store. The driver node downloads the stored virtual environment using the received metadata and initializes an environment at the one or more worker nodes using the downloaded virtual environment. The worker nodes execute the pre-defined functions in the initialized environment.

The disclosed configurations also provide a method (and/or a computer-readable medium or system) for caching a virtual environment. The configuration receives a request from a user to execute code in a notebook. The service initializes a first VM for execution of the code in the notebook based on the request. The first VM may be set up with a virtual environment with configurations for executing the code. The service automatically caches the virtual environment with the configurations in a data store and automatically caches metadata associated with the virtual environment in a metadata store. The metadata may include a location identifier for identifying a caching location of the virtual environment in the data store. The metadata may include an expiration condition. When the virtual environment meets the expiration condition, the virtual environment will be invalidated in the data store. The service executes the code in the notebook in the virtual environment.

Managing dependencies in serverless notebook environments often involves several challenges, particularly when dealing with complex or large dependencies, including those with native extensions or specific system requirements. Although there are existing methods and tools that aid in packaging these dependencies, they are not always sufficient for every situation. Users frequently find themselves needing to manually handle such cases, which can be time-consuming and error-prone. In some instances, additional tooling is required to manage dependencies effectively, especially when the dependencies involve intricate configurations or are reliant on specific system libraries that are not easily portable.

Furthermore, the lack of built-in support for continuous integration and continuous deployment (CI/CD) pipelines poses another significant challenge. CI/CD pipelines are crucial for development workflows as they facilitate automated testing and deployment, ensuring that code changes are continuously integrated, tested, and deployed without manual intervention. Without native CI/CD support, users of serverless environments must integrate external CI/CD tools to establish these automated workflows. This integration can be complex, requiring users to configure and manage the interaction between their serverless environment and the CI/CD systems.

This disclosure presents a method for caching virtual environments, enabling different virtual machines (VMs) to load these cached environments with consistent configurations. This approach ensures that each VM can quickly and reliably access a pre-configured environment, significantly reducing setup times and potential configuration errors. By caching virtual environments, the system can maintain uniformity across various VMs, facilitating a seamless transition and consistent performance when moving workloads between VMs.

Additionally, the disclosure introduces a pipeline for checkpointing/storing virtual environments. This pipeline allows synchronization between VMs and computing clusters for executing a notebook in a serverless system, ensuring that the virtual environment's state is consistently maintained across different computing resources. By checkpointing the virtual environment, any changes made within one VM can be synchronized with the computing clusters, enhancing reliability and consistency in distributed computing setups.

The disclosed configurations monitor dependencies, libraries, etc., installed by any user in real-time. The disclosed configurations, without user intervention, watch for any changes or updates to the dependencies, ensuring that the virtual environment remains up-to-date and consistent with the required configurations. This real-time monitoring helps in identifying and resolving dependency conflicts, reducing the risk of errors due to outdated or incompatible code.

Checkpointing/storing a virtual environment retains all dependencies that users install in their notebooks. This persistent storage mechanism allows for fast and asynchronous storage of these dependencies in the background, ensuring that users do not experience delays or interruptions during their workflow. By storing the virtual environment persistently, the disclosed configurations ensure that all required virtual environments are readily available whenever a virtual environment is loaded, enhancing the efficiency and reliability of the environment setup process.

Furthermore, the disclosed configurations include a mechanism for removing outdated virtual environments using an expiration condition. This approach ensures that only relevant and up-to-date virtual environments are retained, freeing up storage space and reducing clutter. By expiring outdated environments, the disclosed configurations maintain optimal performance and prevent the accumulation of obsolete configurations that could potentially lead to conflicts or errors.

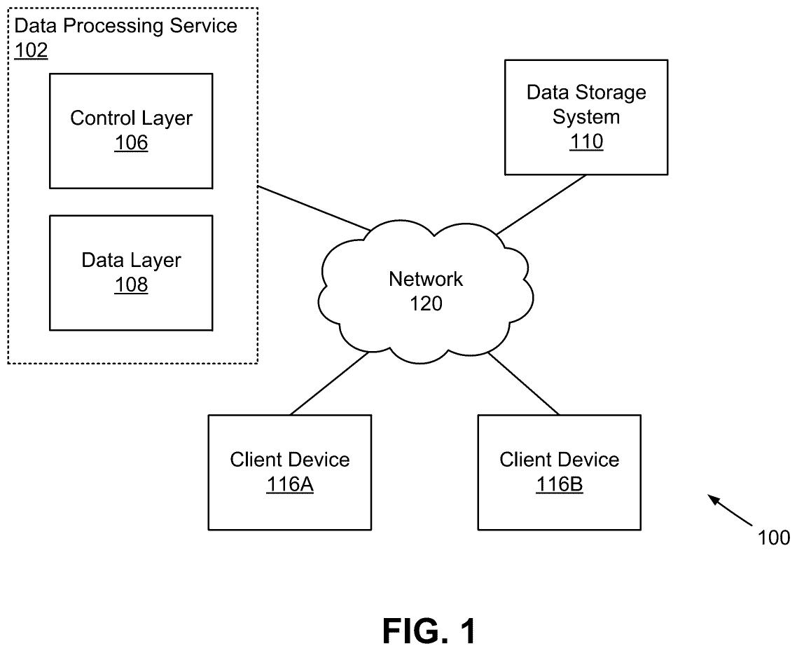

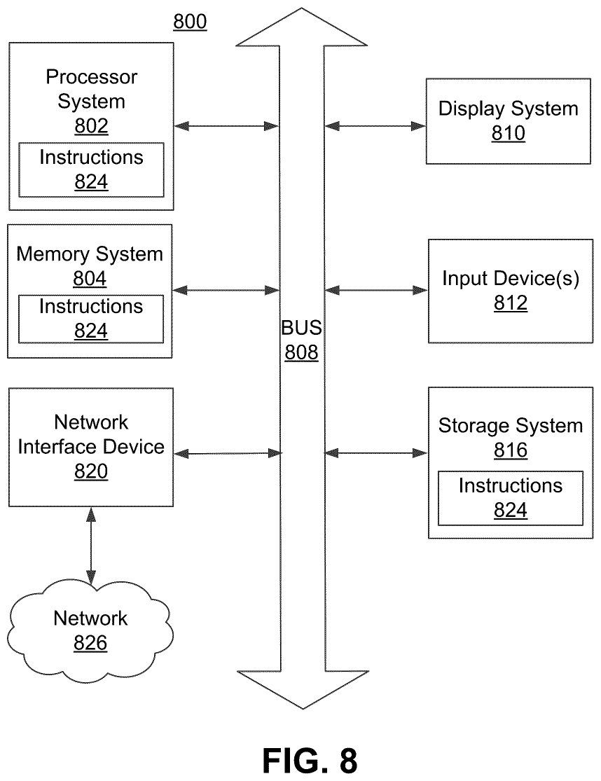

Figure (FIG.) 1 is a high-level block diagram of a system environment 100 for a data processing service 102, in accordance with an embodiment. The system environment 100 shown by FIG. 1 includes one or more client devices 116A, 116B, a network 120, a data processing service 102, and a data storage system 110. In alternative configurations, different and/or additional components may be included in the system environment 100. The computing systems of the system environment 100 may include some or all of the components (systems (or subsystems)) of a computer system 800 as described with FIG. 8.

The data processing service 102 is a service for managing and coordinating data processing services (e.g., database services) to users of client devices 116. The data processing service 102 may manage one or more applications that users of client devices 116 can use to communicate with the data processing service 102. Through an application of the data processing service 102, the data processing service 102 may receive requests (e.g., database queries) from users of client devices 116 to perform one or more data processing functionalities on data stored, for example, in the data storage system 110. The requests may include query requests, analytics requests, or machine learning and artificial intelligence requests, and the like, on data stored by the data storage system 110. The data processing service 102 may provide responses to the requests to the users of the client devices 116 after they have been processed.

In one embodiment, as shown in the system environment 100 of FIG. 1, the data processing service 102 includes a control layer 106 and a data layer 108. The components of the data processing service 102 may be configured by one or more servers and/or a cloud infrastructure platform. In one embodiment, the control layer 106 receives data processing requests and coordinates with the data layer 108 to process the requests from client devices 116. The control layer 106 may schedule one or more jobs for a request or receive requests to execute one or more jobs from the user directly through a respective client device 116. The control layer 106 may distribute the jobs to components of the data layer 108 where the jobs are executed.

The control layer 106 is additionally capable of configuring the clusters in the data layer 108 that are used for executing the jobs. For example, a user of a client device 116 may submit a request to the control layer 106 to perform one or more queries and may specify that four clusters on the data layer 108 be activated to process the request with certain memory requirements. Responsive to receiving this information, the control layer 106 may send instructions to the data layer 108 to activate the requested number of clusters and configure the clusters according to the requested memory requirements.

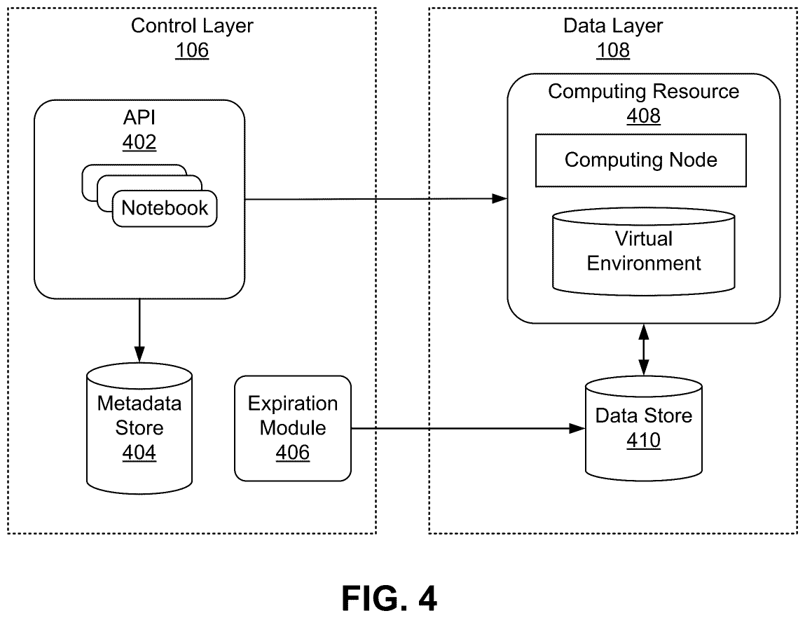

The data layer 108 includes multiple instances of clusters of computing resources that execute one or more jobs received from the control layer 106. Accordingly, the data layer 108 may include a cluster computing system for executing the jobs. An example of a cluster computing system is described in relation to FIG. 4. In one instance, the clusters of computing resources are virtual machines or virtual data centers configured on a cloud infrastructure platform. In one instance, the control layer 106 is configured as a multi-tenant system and the data layers 108 of different tenants are isolated from each other. In one instance, a serverless implementation of the data layer 108 may be configured as a multi-tenant system with strong virtual machine (VM) level tenant isolation between the different tenants of the data processing service 102. Each customer represents a tenant of a multi-tenant system and shares software applications and also resources such as databases of the multi-tenant system. Each tenant's data is isolated and remains invisible to other tenants. For example, a respective data layer instance can be implemented for a respective tenant. However, it is appreciated that in other embodiments, single tenant architectures may be used.

The data layer 108 thus may be accessed by, for example, a developer through an application of the control layer 106 to execute code developed by the developer. In one embodiment, a cluster in a data layer 108 may include multiple worker nodes that execute multiple jobs in parallel. Responsive to receiving a request, the data layer 108 divides the cluster computing job into a set of worker jobs, provides each of the worker jobs to a worker node, receives worker job results, stores job results, and the like. The data layer 108 may include resources not available to a developer on a local development system, such as powerful computing resources to process very large data sets. In this manner, when the data processing request can be divided into jobs that can be executed in parallel, the data processing request can be processed and handled more efficiently with shorter response and processing time.

In one embodiment, the computing resources of the data processing service 102 that access data in the data lake includes a transactional layer (e.g., group of software functionalities) that performs various functionalities, including retrieving the data relevant to the request, perform transaction management to update changes to a data table that comply with atomicity, consistency, isolation, and durability (ACID) transaction properties, and the like. The transactional layer may be configured within a compute resource of the control layer 106 and/or the data layer 108.

Moreover, since data in the data storage system 110 (e.g., cloud object data store) stores unstructured data in addition to structured data, it is difficult to interact with the data in a data lake compared to data stored in, for example, a structured database. Therefore, the transaction layer also generates and maintains one or more metadata files in association with the data files of a data table that allow the transaction layer to navigate the data storage system 110 to retrieve and write data desired by users. Therefore, the data files and/or metadata files of a data table may be stored according to different formats (e.g., schema, organization of files), and a compute resource is able to interact with the data if configured with the transactional layer for that format that includes, for example, libraries for reading or writing data in that format, and the like.

The data storage system 110 includes a device (e.g., a disc drive, a hard drive, a semiconductor memory) used for storing database data (e.g., a stored data set, portion of a stored data set, data for executing a query). In one embodiment, the data storage system 110 includes a distributed storage system for storing data and may include a commercially provided distributed storage system service. Thus, the data storage system 110 may be managed by a separate entity than an entity that manages the data processing service 102 or the data management system 110 may be managed by the same entity that manages the data processing service 102.

The client devices 116 are computing devices that display information to users and communicates user actions to the systems of the system environment 100. While two client devices 116A, 116B are illustrated in FIG. 1, in practice many client devices 116 may communicate with the systems of the system environment 100. In one embodiment, client devices 116 of the system environment 100 may include some or all of the components (systems (or subsystems)) of a computer system 800 as described with FIG. 8.

In one embodiment, a client device 116 executes an application allowing a user of the client device 116 to interact with the various systems of the system environment 100 of FIG. 1. For example, a client device 116 can execute a browser application to enable interaction between the client device 116 and the control layer 106 via the network 120. In another embodiment, the client device 116 interacts with the various systems of the system environment 100 through an application programming interface (API) running on a native operating system of the client device 116, such as IOS® or ANDROID™.

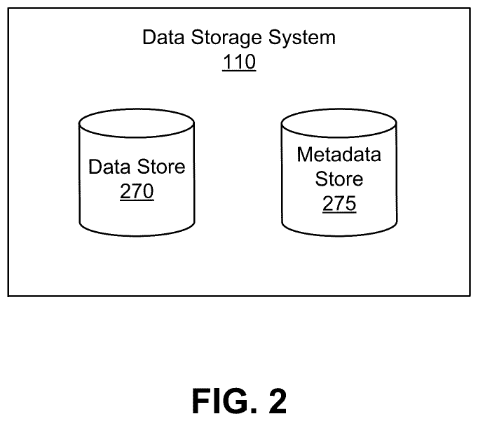

FIG. 2 is a block diagram of an architecture of a data storage system 110, in accordance with an embodiment. In one embodiment, the data storage system 110 includes a data ingestion module 250. The data storage system 110 also includes a data store 270 and a metadata store 275.

The data store 270 stores data associated with different tenants of the data processing service 102. In one embodiment, the data in data store 270 is stored in a format of a data table. A data table may include a plurality of records or instances, where each record may include values for one or more features. The records may span across multiple rows of the data table and the features may span across multiple columns of the data table. In other embodiments, the records may span across multiple columns and the features may span across multiple rows. For example, a data table associated with a security company may include a plurality of records each corresponding to a login instance of a respective user to a website, where each record includes values for a set of features including user login account, timestamp of attempted login, whether the login was successful, and the like. In one embodiment, the plurality of records of a data table may span across one or more data files. For example, a first subset of records for a data table may be included in a first data file and a second subset of records for the same data table may be included in another second data file.

In one embodiment, a data table may be stored in the data store 270 in conjunction with metadata stored in the metadata store 275. In one instance, the metadata includes transaction logs for data tables. Specifically, a transaction log for a respective data table is a log recording a sequence of transactions that were performed on the data table. A transaction may perform one or more changes to the data table that may include removal, modification, and additions of records and features to the data table, and the like. For example, a transaction may be initiated responsive to a request from a user of the client device 116. As another example, a transaction may be initiated according to policies of the data processing service 102. Thus, a transaction may write one or more changes to data tables stored in the data storage system 110.

In one embodiment, a new version of the data table is committed when changes of a respective transaction are successfully applied to the data table of the data storage system 110. Since a transaction may remove, modify, or add data files to the data table, a particular version of the data table in the transaction log may be defined with respect to the set of data files for the data table. For example, a first transaction may have created a first version of a data table defined by data files A and B each having information for a respective subset of records. A second transaction may have then created a second version of the data table defined by data files A, B and in addition, new data file C that include another respective subset of records (e.g., new records) of the data table.

In one embodiment, the transaction log may record each version of the table, the data files associated with a respective version of the data table, information pertaining to the type of transactions that were performed on the data table, the order in which the transactions were performed (e.g., transaction sequence number, a timestamp of the transaction), and an indication of data files that were subject to the transaction, and the like. In some embodiments, the transaction log may include change data for a transaction that also records the changes for data written into a data table with respect to the previous version of the data table. The change data may be at a relatively high level of granularity, and may indicate the specific changes to individual records with an indication of whether the record was inserted, deleted, or updated due to the corresponding transaction.

In one embodiment, the transaction log for a data table in the metadata store 275 includes one or more log files (e.g., JSON files) that capture a transaction to the data table. A log file may include details of one or more transactions made to a respective set of data files of the data table. For example, the log may include the name of the data file, statistics of the data file including min-max ranges for a set of keys, size of the data file, type of transaction (e.g., write, add, update) committed, and the like. The metadata store 275 may also store one or more checkpoint files for the data table. Specifically, a set of checkpoint files describes the state of a data table at a given point in time by analyzing the transactions recorded in the log files until that time. Therefore, metadata for a data table may be characterized by a set of checkpoint files and one or more log files that describe transactions to the data table committed after the set of checkpoint files were created.

In some embodiments, the data store 270 may be configured to store cached virtual environments. The virtual environment may be associated with a VM for executing code in a notebook. The metadata associated with the cached virtual environment may be stored in the metadata store 275, and the metadata may include a location identifier for identifying a caching location of the virtual environment in the data store 270.

In some embodiments, the data store 270 may be configured to store virtual environments for VMs to execute code in a notebook, and the code in the notebook include pre-defined functions. The stored virtual environment may be downloaded by computing clusters for executing the pre-defined functions. The computing clusters are different from the VMs. In some embodiments, the VMs may automatically store the virtual environment in the data store 270 and send the associated metadata to the computing clusters. The associated metadata specifies location information of the virtual environment in the data store 270. The computing cluster may use the associated metadata to locate the virtual environment in the data store 270 and download the virtual environment for executing the pre-defined functions.

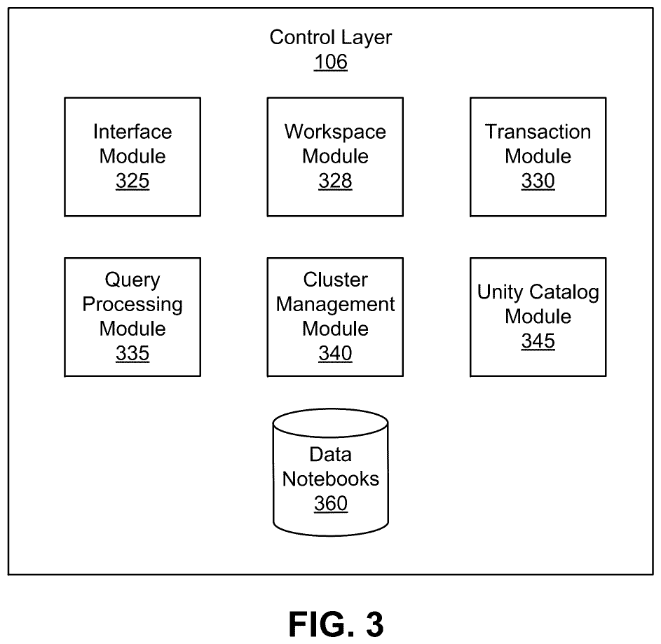

FIG. 3 is a block diagram of an architecture of a control layer 106, in accordance with an embodiment. In one embodiment, the control layer 106 includes an interface module 325, a transaction module 330, a query processing module 335, and a cluster management module 340. The control layer 106 also includes a data notebook store 360. The modules 325, 330, 335, and 340 may be structured for execution by a computer system, e.g., 800 having some or all of the components as described in FIG. 8, such that the computer system 800 operates in a specified manner as per the described functionality.

The interface module 325 provides an interface and/or a workspace environment where users of client devices 116 (e.g., users associated with tenants) can access resources of the data processing service 102. For example, the user may retrieve information from data tables associated with a tenant, submit data processing requests such as query requests on the data tables, through the interface provided by the interface module 325. The interface provided by the interface module 325 may include notebooks, libraries, experiments, queries submitted by the user. In one embodiment, a user may access the workspace via a user interface (UI), a command line interface (CLI), or through an application programming interface (API) provided by the interface module 325.

For example, a notebook associated with a workspace environment is a web-based interface to a document that includes runnable code, visualizations, and explanatory text. A user may submit data processing requests on data tables in the form of one or more notebook jobs. The user provides code for executing the one or more jobs and indications such as the desired time for execution, number of cluster worker nodes for the jobs, cluster configurations, a notebook version, input parameters, authentication information, output storage locations, or any other type of indications for executing the jobs. The user may also view or obtain results of executing the jobs via the workspace.

The workspace module 328 deploys workspaces within the data processing service 102. A workspace as defined herein may refer to a deployment in the cloud that functions as an environment for users of the workspace to access assets. An account of the data processing service 102 represents a single entity that can include multiple workspaces. In one embodiment, an account associated with the data processing service 102 may be associated with one workspace. In another embodiment, an account may be associated with multiple workspaces. A workspace organizes objects, such as notebooks, libraries, dashboards, and experiments into folders. A workspace also provides users access to data objects, such as tables or views or functions, and computational resources such as cluster computing systems.

In one embodiment, a user or a group of users may be assigned to work in a workspace. The users assigned to a workspace may have varying degrees of access permissions to assets of the workspace. For example, an administrator of the data processing service 102 may configure access permissions such that users assigned to a respective workspace are able to access all of the assets of the workspace. As another example, users associated with different subgroups may have different levels of access, for example users associated with a first subgroup may be granted access to all data objects while users associated with a second subgroup are granted access to only a select subset of data objects.

The transaction module 330 receives requests to perform one or more transaction operations from users of client devices 116. As described in conjunction in FIG. 2, a request to perform a transaction operation may represent one or more requested changes to a data table. For example, the transaction may be to insert new records into an existing data table, replace existing records in the data table, delete records in the data table. As another example, the transaction may be to rearrange or reorganize the records or the data files of a data table to, for example, improve the speed of operations, such as queries, on the data table. For example, when a particular version of a data table has a significant number of data files composing the data table, some operations may be relatively inefficient. Thus, a transaction operation may be a compaction operation that combines the records included in one or more data files into a single data file.

The query processing module 335 receives and processes queries that access data stored by the data storage system 110. The query processing module 335 may reside in the control layer 106. The queries processed by the query processing module 335 are referred to herein as database queries. The database queries are specified using a declarative database query language such as the SQL. The query processing module 335 compiles a database query specified using the declarative database query language to generate executable code that is executed. The query processing module 335 may encounter runtime errors during execution of a database query and returns information describing the runtime error including an origin of the runtime error representing a position of the runtime error in the database query. In one embodiment, the query processing module 335 provides one or more queries to appropriate clusters of the data layer 108, and receives responses to the queries from clusters in which the queries are executed.

The unity catalog module 345 is a fine-grained governance solution for managing assets within the data processing service 102. It helps simplify security and governance by providing a central place to administer and audit data access. In one embodiment, the unity catalog module 345 maintains a metastore for a respective account. A metastore is a top-level container of objects for the account. The metastore may store data objects and the permissions that govern access to the objects. A metastore for an account can be assigned to one or more workspaces associated with the account. In one embodiment, the unity catalog module 345 organizes data as a three-level namespace, a catalogue is the first layer, a schema (also called a database) is the second layer, and tables and views are the third layer.

In one embodiment, the unity catalog module 345 enables read and write of data to data stored in cloud storage of the data storage system 110 on behalf of users associated with an account and/or workspace. In one instance, the unity catalog module 345 manages storage credentials and external locations. A storage credential represents an authentication and authorization mechanism for accessing data stored on the data storage system 110. Each storage credential may be subject to access-control policies that control which users and groups can access the credential. An external location is an object that combines a cloud storage path (e.g., storage path in the data storage system 110) with a storage credential that authorizes access to the cloud storage path. Each storage location is subject to access-control policies that control which users and groups can access the storage credential. Therefore, if a user does not have access to a storage credential in the unity catalog module 345, the unity catalog module 345 does not attempt to authenticate to the data storage system 110.

In one embodiment, the unity catalog module 345 allows users to share assets of a workspace and/or account with users of other accounts and/or workspaces. For example, users of Company A can configure certain tables owned by Company A that are stored in the data storage system 110 to be shared with users of Company B. Each organization may be associated with separate accounts on the data processing service 102. Specifically, a provider entity can share access to one or more tables of the provider with one or more recipient entities.

Responsive to receiving a request from a provider to share one or more tables (or other data objects), the unity catalog module 345 creates a share in the metastore of the provider. A share is a securable object registered in the metastore for a provider. A share contains tables and notebook files from the provider metastore that the provider would like to share with a recipient. A recipient object is an object that associates an organization with a credential or secure sharing identifier allowing that organization to access one or more shares of the provider. In one embodiment, a provider can define multiple recipients for a given metastore. The unity catalog module 345 in turn may create a provider object in the metastore of the recipient that stores information on the provider and the tables that the provider has shared with the recipient. In this manner, a user associated with a provider entity can securely share tables of the provider entity that are stored in a dedicated cloud storage location in the data storage system 110 with users of a recipient entity by configuring shared access in the metastore.

### Serverless Environment Caching

FIG. 4 is a block diagram of an architecture of the control layer 106 and the data layer 108 for performing serverless environment caching, in accordance with an embodiment. The control layer 106 may include an application programming interface (API) 402 and a metadata store 404. In some embodiments, the control layer 106 may include an expiration module 406. The data layer 108 may include a computing resource 408 and a data store 410. The components included in the control layer 106 and data layer 108 may be structured for execution by a computer system, e.g., 800 having some or all of the components as described in FIG. 8, such that the computer system 800 operates in a specified manner as per the described functionality.

The API 402 provides an interface where users of the client devices 116 can access resources of the data processing service 102. In some implementations, the API 402 may run on a native operating system of the client devices 116. In one example, the API 402 may be a web-based interface associated with one or more notebooks. A notebook may include executable (e.g., runnable) code, visualizations, libraries, dependencies, etc. The API 402 provides an interface for users to write, execute, and visualize code included in the one or more notebooks.

The computing resource 408 provides computational resources necessary to execute the code in the one or more notebooks. In some embodiments, the computing resource 408 may include one or more computing nodes and each computing node may be associated with a notebook. In some examples, a computing node may be a virtual machine (VM), and a notebook may be attached to a VM, i.e., connecting the notebook to the VM so that the code written and executed within the notebook can run on the VM. In some implementations, attaching a notebook to a VM may include initiating a VM and setting up a virtual environment in the VM. A virtual environment for a VM to execute a notebook may include isolated and specific configurations of software dependencies and packages needed to run the code within the notebook. Configurations of a virtual environment may refer to the configurations of dependencies, environment variables and configuration files that are set up to provide necessary settings and credentials for running the code within the notebook. For example, the configuration of dependencies in a virtual environment involves specifying and controlling the libraries and packages used by the virtual environment. For Python environments, this is typically managed through files like requirements.txt or Pipfile, which list the packages and their versions. These configurations ensure that the virtual environment consistently uses the correct versions of libraries, which is crucial for avoiding compatibility issues and ensuring that applications run as expected. The environment variables, which may include sensitive information such as API keys, database connection strings, or other critical settings, are often stored in configuration files like. env files or set directly in the environment. The environment variables defined in the virtual environment can control various aspects of application behavior, such as connecting to external services, setting operational modes (e.g., development or production), and configuring application-specific settings.

Initializing a virtual environment with configurations for execution of code in a notebook may include downloading libraries, dependencies, code, etc., and integrating the environment with the notebook. The virtual environment may allow for the installation of specific versions of libraries and packages required for a notebook to run, including programming language interpreters (e.g., Python, R, etc.), data processing libraries (e.g., Pandas, NumPy, etc.), machine learning frameworks (e.g., TensorFlow, PyTorch, etc.), and the like. In some implementations, when a notebook is executed, the code runs within the context of a virtual environment on the VM. Commands, scripts, and functions executed in the notebook have access to the dependencies and configurations specified in the virtual environment. In some embodiments, a virtual environment may be used for isolation so that the software dependencies for one notebook do not interfere with those of another.

In some embodiments, the computing resource 408 may cache a virtual environment associated with a notebook so that the configuration and installed dependencies remain across sessions and reboots. For example, by caching the virtual environment, the configuration remains intact even after the VM is restarted and/or a new VM is initialized. The computing resource 408 may store the cached virtual environment in the data store 410. In some implementations, the data store 410 may be the data store 270 of the data storage system 110; alternatively, the data store 410 may be a separate data store. In some embodiments, the computing resource 408 may include an environment watcher that monitors the state of the virtual environment. In one example, a user installs libraries and modifies code in the notebook, and the environment watcher may monitor and record any changes made to the notebook. For example, a virtual environment is updated by adding new dependencies, such as introducing new libraries or packages that the code relies on. For instance, the update involves adding new entries to requirements.txt for Python or package.json for Node.js, which requires updates to package managers and potentially new installation steps. In some implementations, the environment watcher may keep a log of mutations made to the virtual environment, recording changes to the virtual environment, such as updates to dependencies, environment variables, configuration files, etc. The environment watcher may update the cached virtual environment incrementally. For example, the environment watcher may set a condition for caching/updating the virtual environment. The condition may be a critical mass of mutations that have been made since the last caching of the virtual environment. The critical mass of mutations may be associated with time, size, raw volume of packages, batches of libraries. Once the critical mass of mutations has been made, e.g., certain batches of libraries are installed since last caching, the computing resource 408 may update the cached virtual environment in the data store 410. In some embodiments, the computing resource 408 may determine a change to the code in the notebook and incrementally update the cached virtual environment based on the determined change.

In some embodiments, the metadata store 404 may include metadata that describes information of the associated cached virtual environment. In some implementations, the metadata store 404 may be the metadata store 275 of the data storage system 110; alternatively, the metadata store 404 may be a separate metadata store. In some examples, the metadata may include information for identifying the associated cached virtual environment in the data store 410. For example, the metadata may include an identifier for identifying the virtual environment, a location identifier for identifying a caching location of the virtual environment in the data store 410, and the like.

In one implementation, the computing resource 408 may initialize a first VM for executing the code in a notebook. The first VM may set up a virtual environment with configurations for running the code in the notebook. The virtual environment may be automatically cached in the data store 410 and the associated metadata may be stored in the metadata store 404. In some cases, after the first VM is removed from the virtual environment (e.g., a user session ends), the user may request to execute the same notebook. Instead of initializing a second VM by setting up the virtual environment again, the API 402 may access the metadata store 404 and determine whether a virtual environment associated with the notebook is cached in the data store 410. The second VM may be a different VM from the first VM. If the API 402, by checking the associated metadata in the metadata store 404, determines that a cached virtual environment exists in the data store 410, the computing resource 408 will download the cached virtual environment from the data store 410 and initialize the second VM with the cached virtual environment for execution of the notebook.

In some embodiments, the expiration module 406 is configured to determine an expiration condition for a cached virtual environment. The expiration module 406 may use the metadata to determine whether a cached virtual environment meets the expiration condition. In some embodiments, the expiration module 406 may configure a time to live (TTL) as an expiration condition for removing/cleaning the cached virtual environment from the data store 410. TTL refers to the amount of time that cached virtual environment is set to exist before removal. For example, a TTL may be set to be as a preset value, e.g., 2 weeks. In some implementations, the metadata associated with a cached virtual environment may include a timestamp. Once the expiration condition is met, the cached virtual environment may be removed from the data store 410.

### Serverless Environment Synchronization

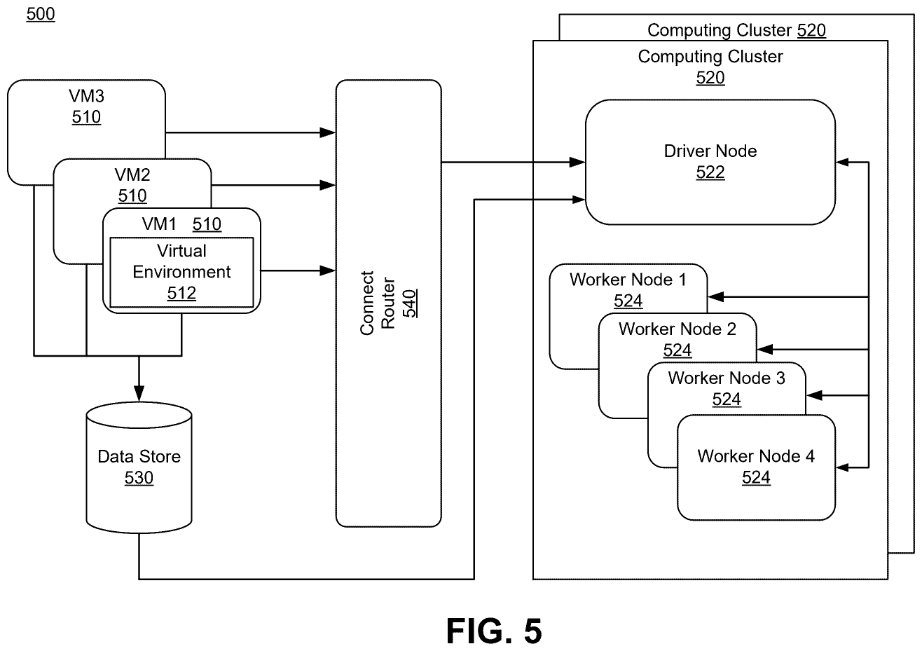

FIG. 5 is a block diagram illustrating a process 500 of synchronizing a virtual environment, in accordance with an embodiment. In some embodiments, different and/or additional components may be included in performing the process 500. In some embodiments, the components may be structured for execution by a computer system, e.g., 800 having some or all of the components as described in FIG. 8, such that the computer system 800 operates in a specified manner as per the described functionality.

In some embodiments, the code run in a notebook may include one or more pre-defined functions, e.g., user-defined functions (UDFs). For example, in serverless notebooks, one or more VMs 510 may be configured to execute local code within the notebook interface. Pre-defined functions, such as distributed data processing jobs may be executed by one or more computing clusters 520. A computing cluster 520 may be a separate set of VMs or physical servers designed to handle distributed computing. The VMs 510 and the computing clusters 520 may be logically and physically separated. For example, the one or more computing clusters 520 may be remote from the VMs 510 that execute the notebooks. In some implementations, the VMs 510 may be configured for quick responsiveness, handling user inputs, executing Python, Scala, or R code directly, and providing immediate feedback, and the large-scale data processing tasks are handled by the one or more computing clusters 520.

FIG. 5 illustrates a process for synchronizing the virtual environments 512 between VMs 510 and the computing clusters 520. As shown in FIG. 5, one or more VMs 510 may be initialized to execute one or more notebooks. Each VM 510 may be configured with one or more virtual environments 512, and each virtual environment 512 is associated with a notebook. When running the code in a notebook, the code may be initially executed by the VM 510, and when encountering one or more pre-defined functions, the VM 510 may access a computing cluster 520 for execution of the one or more pre-defined functions.

To ensure that the virtual environments 512 between the VMs 510 and the computing clusters 520 are synchronized, the VMs 510 may store the virtual environments 512 in a data store 530. The stored virtual environments 512 may be a snapshot of the virtual environments 512, including all installed libraries, dependencies, functions, etc., and their respective versions of the associated notebook. In some implementations, the VMs 510 may store the virtual environment 512 as a compressed archive file and upload the stored virtual environment 512 in the data store 530. The data store 530 may be the data store 270 of the data storage system 110; alternatively, the data store 530 may be a separate data store. In some embodiments, the data store 530 may be a type of object storage storing large amounts of unstructured data, such as media files, logs, etc. In some embodiments, the data store 530 may include a shared file system.

In some embodiments, the VMs 510 may generate metadata for describing the information of the stored virtual environments 512. In some implementations, the metadata may include a pre-determined uniform resource locator (URL) for identifying the stored virtual environments 512 in the data store 530. For example, the virtual environments 512 may generate pre-determined URLs for uploading and downloading the virtual environment 512. These URLs allow the users to securely upload the virtual environment 512 (which includes all necessary dependencies) to the data store 530 without directly handling storage credentials. The URLs may also include time-limited restrictions for the upload and download operations.

After uploading the virtual environments 512 to the data store 530, the virtual environments 512 may provide the metadata to the corresponding computing cluster 520. In one implementation, the VMs 510 may inject the pre-determined URL along with any other relevant metadata into a request or a session for execution of the notebook. In some embodiments, communication between the VMs 510 and the one or more computing clusters 520 is performed by a connect router 540 which provides protocols for the connection between the VMs 510 and the one or more computing clusters 520. When a pre-defined function is initiated/activated from the notebook, the VM 510 transmits (sends) a job instruction to the computing cluster 520 via the connection protocol provided by the connect router 540. In some implementations, the connection protocol permits executing the one or more pre-defined functions in the virtual environment which is set up for the corresponding notebook but prevents executing the one or more pre-defined functions in a virtual environment which is set up for a different notebook. In this way, the connection protocol ensures that the job instructions are transmitted securely and efficiently, allowing the one or more computing clusters 520 to execute the tasks on its distributed resources.

The computing clusters 520 receive the metadata of the stored virtual environments 512 and download the virtual environments 512 from data store 530 before executing the one or more pre-defined functions. For example, the metadata may include a pre-determined download URL for the one or more computing clusters 520 to identify and locate the corresponding virtual environments 512 in the data store 530. In some implementations, the computing clusters 520 may download the stored virtual environments 512 before executing each pre-defined function, ensuring that the virtual environment 512 is synchronized with the latest version for each execution. By downloading and unpacking the stored virtual environments 512, the computing clusters 520 initialize and reconstruct the virtual environments 512, mirroring the configuration in the VMs 510, e.g., all dependencies and configurations are aligned, providing a consistent runtime environment.

In some embodiments, the computing cluster 520 includes a driver node 522 and a worker pool including multiple worker nodes 524. The driver node 522 receives one or more jobs for execution, divides a job into job stages, and provides job stages to worker nodes 524, receives job stage results from the worker nodes 524 of the worker pool, and assembles job stage results into complete job results, and the like. For example, the driver node 522 receives a request to execute one or more pre-defined functions. The driver node 522 may generate an execution plan. The driver node 522 distributes information of the pre-defined functions including the generated code to the worker nodes 524. The worker nodes 524 execute the pre-defined functions based on the received information. In some implementations, the driver node 522 is the central coordinator that manages the execution of the pre-defined functions. The driver node 522 downloads the virtual environments 512 from the data store 530 using the metadata of the virtual environments 512 and assigns tasks to the worker nodes 524.

The worker pool can include any appropriate number of worker nodes 524 (e.g., 4 worker nodes, 12 worker nodes, 256 worker nodes). Each worker node 524 in the worker pool includes one or more execution engines (not shown) for executing one or more tasks of a job stage (e.g., a pre-defined function). In one embodiment, an execution engine performs single-threaded task execution in which a task is processed using a single thread of the CPU. The worker node 524 distributes one or more tasks for a job stage to the one or more execution engines and provides the results of the execution to the driver node 522. According to an embodiment, a worker node 524 executes the generated code for the pre-defined functions. The worker nodes 524 execute the pre-defined functions based on the received information from the driver node 522.

In some embodiments, the driver node 522 may set up a shared file system in the computing cluster 520 so that the worker nodes 524 may share the virtual environments 512 downloaded by the driver node 522 in the same computing cluster 520. The shared file system may also prevent the worker nodes 524 from accessing a virtual environment 512 that is downloaded by a driver node 522 in a different computing cluster 520. The driver node 522 ensures that each worker nodes 524 receives the stored virtual environment 512 with the same set of dependencies and libraries, maintaining consistency across the distributed tasks.

In some embodiments, the metadata of the virtual environment 512 may include a version number indicating a version of the stored virtual environments 512 in the data store. When downloading the virtual environment 512, the driver node 522 may determine whether a current version number of the virtual environment 512 is different from a previous version number of the virtual environment 512 which was previously downloaded. Responsive to the current version number being different from the previous version number, the driver node 522 may download the stored virtual environment 512 with the current version number. If the current version number is the same as the previous version number, the driver node 522 may directly use the previously downloaded virtual environment 512 for executing the one or more pre-defined functions.

In some embodiments, the VMs 510 may include an environment watcher that automatically monitors the state of the virtual environment. When detecting a change to the code in a notebook, the VMs 510 may incrementally update the stored virtual environment 512 based on the detected change and update the metadata to indicate the change. In some implementations, the VMs 510 may send the updated metadata to the one or more computing clusters 520 so that the driver node 522 may download the latest version of the virtual environments 512 using the updated metadata. In some embodiments, the metadata may include an expiration condition for removing the stored virtual environments 512 from the data store 530. For example, the expiration condition may be a TTL, setting the amount of time that stored virtual environment can exist before removal. Once the expiration condition is met, the stored virtual environment 512 may be removed from the data store 530.

### Process of Synchronizing Virtual Environment

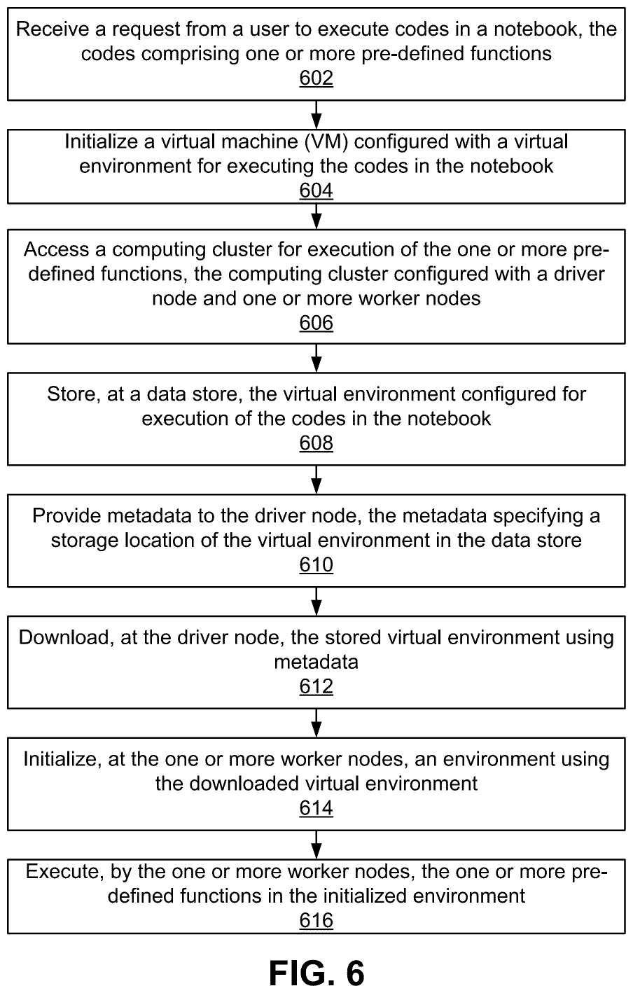

FIG. 6 is a flowchart of a method for synchronizing a virtual environment, in accordance with an embodiment. The process shown in FIG. 6 may be performed by one or more components of a data processing system/service (e.g., the data processing service 102). Other entities may perform some or all of the steps in FIG. 6. The data processing service 102 as well as the other entities may include some or all of the components of the machine (e.g., computer system) described in conjunction with FIG. 8. Embodiments may include different and/or additional steps, or perform the steps in different orders.

As shown in FIG. 6, the data processing service 102 may receive 602 a request from a user to execute code in a notebook. The code may include one or more pre-defined functions. The data processing service 102 may initialize 604 a VM for executing the code in the notebook, and the VM is configured with a virtual environment. The data processing service 102 accesses 606 a computing cluster for execution of the one or more pre-defined functions. The computing cluster may include a driver node and one or more worker nodes. The data processing service 102 stores 608 the virtual environment in a data store and provides 610 metadata to the driver node. The metadata specifies a storage location of the virtual environment in the data store. The driver node downloads 612 the stored virtual environment using the received metadata and initializes 614 an environment at the one or more worker nodes using the downloaded virtual environment. The one or more worker nodes execute 616 the one or more pre-defined functions in the initialized environment.

### Process of Caching Virtual Environment

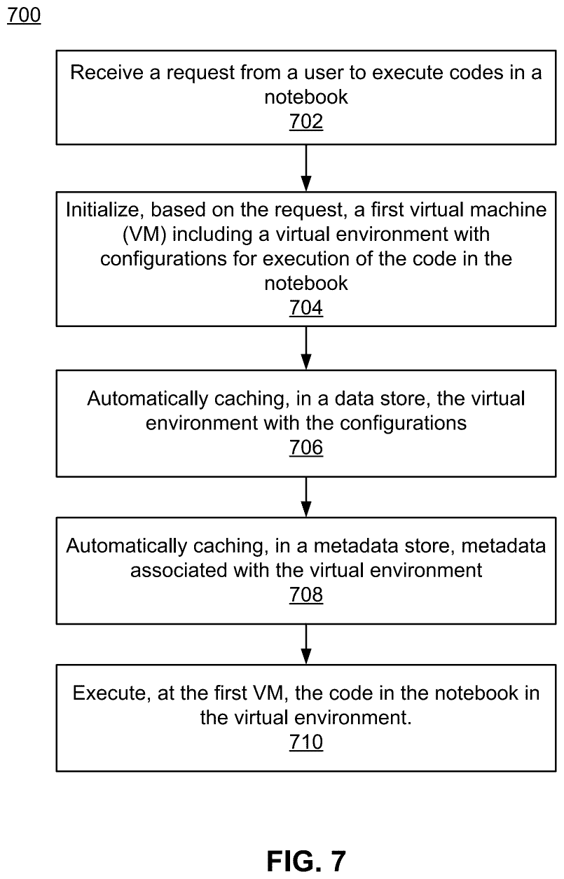

FIG. 7 is a flowchart of a method for caching a virtual environment, in accordance with an embodiment. The process shown in FIG. 7 may be performed by one or more components (e.g., the control layer 106, the data layer 108) of a data processing system/service (e.g., the data processing service 102). Other entities may perform some or all of the steps in FIG. 7. The data processing service 102 as well as the other entities may include some or all of the components of the machine (e.g., computer system) described in conjunction with FIG. 7. Embodiments may include different and/or additional steps or perform the steps in different order.

As shown in FIG. 7, the data processing service 102 may receive 702 a request from a user to execute code in a notebook and initialize 704 a first VM for execution of the code in the notebook based on the request. The first VM may be set up with a virtual environment with configurations for executing the code. The data processing service 102 may automatically cache 706 the virtual environment with the configurations in a data store and automatically cache 708 the metadata associated with the virtual environment in a metadata store. The metadata may include a location identifier for identifying a caching location of the virtual environment in the data store. In some embodiments, the metadata may include an expiration condition. When the virtual environment meets the expiration condition, the virtual environment will be invalidated in the data store, for example, by removing, deleting the cached/stored virtual environment from the data store, triggering a request for updating the virtual environment, or preventing access to the cached/stored virtual environment. The data processing service 102 may execute 710 the code in the notebook in the virtual environment.

In some embodiments, the data processing service 102 may receive a subsequent request for executing code in the notebook. The data processing service 102 determines whether the virtual environment associated with the notebook is cached in the data store. For example, the data processing service 102 may identify, from the metadata store, the metadata associated with the virtual environment. Responsive to determining that the virtual environment is cached in the data store, the data processing service 102 may download, based on the identified metadata, the virtual environment from the data store to a second VM. The first VM and the second VM may be different VMs. The data processing service 102 then initializes the second VM that is configured with a local environment using the downloaded virtual environment and executes the code in the notebook in the local environment of the second VM.

Turning now to FIG. 8, illustrated is an example machine to read and execute computer readable instructions, in accordance with an embodiment. Specifically, FIG. 8 shows a diagrammatic representation of the data processing service 102 (and/or data processing system) in the example form of a computer system 800. The computer system 800 is structured and configured to operate through one or more other systems (or subsystems) as described herein. The computer system 800 can be used to execute instructions 824 (e.g., program code or software) for causing the machine (or some or all of the components thereof) to perform any one or more of the methodologies (or processes) described with FIGS. 1-7 herein. In executing the instructions, the computer system 800 operates in a specific manner as per the functionality described. The computer system 800 may operate as a standalone device or a connected (e.g., networked) device that connects to other machines. In a networked deployment, the machine may operate in the capacity of a server machine or a client machine in a server-client network environment, or as a peer machine in a peer-to-peer (or distributed) network environment.

The computer system 800 may be a server computer, a client computer, a personal computer (PC), a tablet PC, a smartphone, an internet of things (IoT) appliance, a network router, switch or bridge, or other machine capable of executing instructions 824 (sequential or otherwise) that enable actions as set forth by the instructions 824. Further, while only a single machine is illustrated, the term “machine” shall also be taken to include any collection of machines that individually or jointly execute instructions 824 to perform any one or more of the methodologies discussed herein.

The example computer system 800 includes a processing system 802. The processor system 802 includes one or more processors. The processor system 802 may include, for example, a central processing unit (CPU), a graphics processing unit (GPU), a neural processing unit (NPU), a digital signal processor (DSP), a controller, a state machine, one or more application specific integrated circuits (ASICs), one or more radio-frequency integrated circuits (RFICs), or any combination of these. The processor system 802 executes an operating system for the computing system 800. The computer system 800 also includes a memory system 804. The memory system 804 may include or more memories (e.g., dynamic random access memory (RAM), static RAM, cache memory). The computer system 800 may include a storage system 816 that includes one or more machine readable storage devices (e.g., magnetic disk drive, optical disk drive, solid state memory disk drive).

The storage unit 816 stores instructions 824 (e.g., software) embodying any one or more of the methodologies or functions described herein. For example, the instructions 824 may include instructions for implementing the functionalities of the transaction module 330 and/or the file management module 335. The instructions 824 may also reside, completely or at least partially, within the memory system 804 or within the processing system 802 (e.g., within a processor cache memory) during execution thereof by the computer system 800, the main memory 804 and the processor system 802 also constituting machine-readable media. The instructions 824 may be transmitted or received over a network 826, such as the network 826, via the network interface device 820.

The storage system 816 should be taken to include a single medium or multiple media (e.g., a centralized or distributed database, or associated caches and servers communicatively coupled through the network interface system 820) able to store the instructions 824. The term “machine-readable medium” shall also be taken to include any medium that is capable of storing instructions 824 for execution by the machine and that cause the machine to perform any one or more of the methodologies disclosed herein. The term “machine-readable medium” includes, but not be limited to, data repositories in the form of solid-state memories, optical media, and magnetic media.

In addition, the computer system 800 can include a display system 810. The display system 810 may include driver firmware (or code) to enable rendering on one or more visual devices, e.g., drive a plasma display panel (PDP), a liquid crystal display (LCD), or a projector. The computer system 800 also may include one or more input/output systems 812. The input/output (IO) systems 812 may include input devices (e.g., a keyboard, mouse (or trackpad), a pen (or stylus), microphone) or output devices (e.g., a speaker). The computer system 800 also may include a network interface system 820. The network interface system 820 may include one or more network devices that are configured to communicate with an external network 826. The external network 826 may be wired (e.g., ethernet) or wireless (e.g., WiFi, BLUETOOTH, near field communication (NFC)).

The processor system 802, the memory system 804, the storage system 816, the display system 810, the IO systems 812, and the network interface system 820 are communicatively coupled via a computing bus 808.

### Additional Considerations

The disclosed configurations provide a method (and/or a computer-readable medium or system) of caching a virtual environment configured for executing a notebook in a serverless environment so that different VMs can load the cached virtual environment with the same configuration and execute the notebook in the cached virtual environment. The disclosed configurations also provide a method of checkpointing/storing a virtual environment configured for executing a notebook in a serverless environment. The code of the notebook may include pre-defined functions that need to be executed by computing clusters, while the local code of the notebook is executed by VMs. The VMs and the computing clusters are logically and physically separated. By checkpointing the virtual environment, the virtual environment can be synchronized between the VMs and the computing clusters.

The foregoing description of the embodiments of the disclosed subject matter have been presented for the purpose of illustration; it is not intended to be exhaustive or to limit the disclosed embodiments to the precise forms disclosed. Persons skilled in the relevant art can appreciate that many modifications and variations are possible in light of the disclosed subject matter.

Some portions of this description describe various embodiments of the disclosed subject matter in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the disclosed subject matter may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the present disclosure may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the disclosed embodiments be limited not by this detailed description, but rather by any claims that issue on an application based hereon. Accordingly, the disclosure of the embodiments of the disclosed subject matter is intended to be illustrative, but not limiting, of the scope of the subject matter, which is set forth in the following claims.

What is claimed is:

1. A method comprising:
receiving a request from a user to execute code in a notebook;
initiating, based on the request, a first virtual machine (VM) including a virtual environment with configurations for execution of the code in the notebook;
automatically caching, in a data store, the virtual environment with the configurations;
automatically caching, in a metadata store, metadata associated with the virtual environment, the metadata describing information of the virtual environment; and
executing, at the first VM, the code in the notebook in the virtual environment.

2. The method of claim 1, further comprising:
receiving a subsequent request for executing code in the notebook;
determining whether the virtual environment associated with the notebook is cached in the data store by identifying, from the metadata store, the metadata associated with the virtual environment;
responsive to determining that the virtual environment is cached in the data store, downloading, based on the identified metadata, the virtual environment from the data store to a second VM;
initiating the second VM configured with a local environment using the downloaded virtual environment; and
executing, at the second VM, the code in the notebook in the local environment.

3. The method of claim 2, wherein the first VM is different from the second VM.

4. The method of claim 1, wherein the associated metadata comprises an expiration condition for the virtual environment.

5. The method of claim 4, further comprising:
determining, using the associated metadata, whether the virtual environment meets the expiration condition; and
responsive to the virtual environment meeting the expiration condition, invalidating the virtual environment in the data store.

6. The method of claim 1, wherein the associated metadata comprises a location identifier for identifying a caching location of the virtual environment in the data store.

7. The method of claim 1, wherein automatically caching the virtual environment comprises:
determining a change to the code in the notebook;
incrementally updating, in the data store, the virtual environment based on the change; and
updating the associated metadata to indicate the update to the virtual environment.

8. A non-transitory computer readable storage medium comprising instructions, the instructions when executed cause a processor system to:
receive a request from a user to execute code in a notebook;
initiate, based on the request, a first virtual machine (VM) including a virtual environment with configurations for execution of the code in the notebook;
automatically cache, in a data store, the virtual environment with the configurations;
automatically cache, in a metadata store, metadata associated with the virtual environment, the metadata describing information of the virtual environment; and
execute, at the first VM, the code in the notebook in the virtual environment.

9. The non-transitory computer readable storage medium of claim 8, wherein the instructions when executed further cause the processor system to:
receive a subsequent request for executing code in the notebook;
determine whether the virtual environment associated with the notebook is cached in the data store by identifying, from the metadata store, the metadata associated with the virtual environment;
download, based on the identified metadata, the virtual environment from the data store to a second VM when determined that the virtual environment is cached in the data store;
initiate the second VM configured with a local environment using the downloaded virtual environment; and
execute, at the second VM, the code in the notebook in the local environment.

10. The non-transitory computer readable storage medium of claim 9, wherein the first VM is different from the second VM.

11. The non-transitory computer readable storage medium of claim 8, wherein the associated metadata comprises an expiration condition for the virtual environment.

12. The non-transitory computer readable storage medium of claim 11, wherein the instructions when executed further cause the processor system to:
determine, using the associated metadata, whether the virtual environment meets the expiration condition; and
invalidate the virtual environment in the data store when the virtual environment meets the expiration condition.

13. The non-transitory computer readable storage medium of claim 8, wherein the associated metadata comprises a location identifier for identifying a caching location of the virtual environment in the data store.

14. The non-transitory computer readable storage medium of claim 8, wherein the instructions to automatically cache the virtual environment, when executed further cause the processor system to:
determine a change to the code in the notebook;
incrementally update, in the data store, the virtual environment based on the change; and
update the associated metadata to indicate the update to the virtual environment.

15. A system comprising:
one or more computer processors; and
one or more computer-readable mediums storing instructions that, when executed by the one or more computer processors, cause the system to:
receive a request from a user to execute code in a notebook;
initiate, based on the request, a first virtual machine (VM) including a virtual environment with configurations for execution of the code in the notebook;
automatically cache, in a data store, the virtual environment with the configurations;
automatically cache, in a metadata store, metadata associated with the virtual environment, the metadata describing information of the virtual environment; and
execute, at the first VM, the code in the notebook in the virtual environment.

16. The system of claim 15, wherein the instructions when executed by the one or more computer processors, further cause the system to:
receive a subsequent request for executing code in the notebook;
determine whether the virtual environment associated with the notebook is cached in the data store by identifying, from the metadata store, the metadata associated with the virtual environment;
download, based on the identified metadata, the virtual environment from the data store to a second VM when determining that the virtual environment is cached in the data store;
initiate the second VM configured with a local environment using the downloaded virtual environment; and
execute, at the second VM, the code in the notebook in the local environment.

17. The system of claim 16, wherein the first VM is different from the second VM.

18. The system of claim 15, wherein the associated metadata comprises an expiration condition for the virtual environment, and the instructions when executed by the one or more computer processors, further cause the processor system to:
determine, using the associated metadata, whether the virtual environment meets the expiration condition; and
invalidate the virtual environment in the data store when the virtual environment meets the expiration condition.

19. The system of claim 15, wherein the associated metadata comprises a location identifier for identifying a caching location of the virtual environment in the data store.

20. The system of claim 15, wherein the instructions to automatically cache the virtual environment, when executed further cause the processor system to:
determine a change to the code in the notebook;
incrementally update, in the data store, the virtual environment based on the change; and
update the associated metadata to indicate the update to the virtual environment.
